(19) United States
(12) Patent Application Publication
(10) Pub. No.: US 2022/0284126 A1
(43) Pub. Date: Sep. 8, 2022

(54) ANONYMIZATION-PROCESSING EVALUATION SYSTEM, ANONYMIZATION-PROCESSING EVALUATION METHOD, AND COMPUTER READABLE MEDIUM

(71) Applicant: Mitsubishi Electric Corporation, Tokyo (JP)

(72) Inventor: Masahiro FUJITA, Tokyo (JP)

(73) Assignee: Mitsubishi Electric Corporation, Tokyo (JP)

(21) Appl. No.: 17/751,265

(22) Filed: May 23, 2022

Related U.S. Application Data
(63) Continuation of application No. PCT/JP2020/000833, filed on Jan. 14, 2020.

(51) Int. Cl. G06F 21/62; G06F 21/31; G06F 21/78

(52) U.S. Cl. CPC G06F 21/6254; G06F 21/31; G06F 21/78

(57) ABSTRACT

A data reception unit (110) receives personal information data, anonymization-processed data, and means-specifying data. A means evaluation unit (120) performs, based on the personal information data and the anonymization-processed data, means evaluation which determines whether or not conversion from the personal information into the anonymization-processed personal information has been performed by applying the anonymization-processing rule specified by the means-specifying data. A criterion evaluation unit (130) performs, based on criterion determination data, criterion evaluation which determines an anonymization-processing criterion for a criterion determination rule which is the same as the anonymization-processing rule specified by the means-specifying data. A result output unit (140) integrates and outputs a result of the means evaluation and a result of the criterion evaluation.

### CROSS REFERENCE TO RELATED APPLICATION

This application is a Continuation of PCT International Application No. PCT/JP2020/000833, filed on Jan. 14, 2020, which is hereby expressly incorporated by reference into the present application.

### TECHNICAL FIELD

The present disclosure relates to a technique of evaluating anonymization processing performed on personal information.

### BACKGROUND ART

With development of Internet technology, practice by a business to collect and utilize personal data has become popular.

As to the utilization of the personal data, there is movement toward utilization of processed personal data after processing which makes it difficult to identify an individual is performed on the personal data. Thereby, both protection of the personal data and the utilization of the personal data are achieved.

As a processing technique which makes it difficult to identify the personal data, there is an anonymization-processing technique.

The anonymization-processing technique includes a plurality of methods such as k-anonymity and a differential-privacy method. Anonymization-processed data is generated by adopting each method or a combination of a plurality of methods.

As to utilization of the anonymization-processing technique, it is necessary to evaluate whether or not a means of performing the anonymization processing (anonymization-processing means) is a proper means of making it difficult to identify the individual.

Patent Literature 1 discloses an evaluation method that can evaluate k-anonymity-processed data.

### CITATION LIST

### Patent Literature

Patent Literature 1: JP2017-228255A

### SUMMARY OF INVENTION

### Technical Problem

An evaluation criterion for whether or not the anonymization-processing means is proper is sometimes decided by a legal system. For example, under the law of Japan, five criteria are indicated in Article 36, Paragraph 1 of the Act on the Protection of Personal Information (revised by Act No. 57 of 2003, Act No. 65 of 2015, and Act No. 51 of 2016) and Article 19 of Enforcement Rules for the Act on the Protection of Personal Information (Rules of the Personal Information Protection Commission No. 3 of 2016). Therefore, as to whether or not the anonymization-processing means is proper, it is possible to refer to the criteria written in the legal system and evaluate whether or not the anonymization-processing means conforms to the criteria.

A method of Patent Literature 1 is for evaluating whether or not the anonymization-processing means is proper, based on a statistical value of a result obtained by comparing personal data with anonymization-processed data. In the Patent Literature 1, conformity to the legal system is not taken into account.

Further, as to evaluation on the legal system conformity of the anonymization-processing means, it is necessary to evaluate whether or not the anonymization-processed data is generated using the anonymization-processing means intended by a practitioner of the anonymization processing.

However, the method of the Patent Literature 1 focuses on only the personal data and the anonymization-processed data. The patent Literature 1 does not consider whether or not used anonymization-processing means is the intended anonymization-processing means.

The present disclosure aims to enable evaluating conformity to a legal system and evaluating whether or not anonymization-processed data is certainly processed in an anonymization-processing means subject to the evaluation.

### Solution to Problem

An anonymization-processing evaluation system according to the present disclosure includes:

a data reception unit to receive personal information data indicating personal information, anonymization-processed data indicating anonymization-processed personal information, and means-specifying data for specifying an anonymization-processing rule which is for the personal information;

a means evaluation unit to perform, based on the personal information data and the anonymization-processed data, means evaluation which determines whether or not conversion from the personal information into the anonymization-processed personal information has been performed by applying the anonymization-processing rule specified by the means-specifying data;

a criterion evaluation unit to perform, based on criterion determination data indicating one or more criterion determination rules for one or more anonymization-processing criteria, criterion evaluation which determines an anonymization-processing criterion for a criterion determination rule which is the same as the anonymization-processing rule specified by the means-specifying data; and

a result output unit to integrate and output a result of the means evaluation and a result of the criterion evaluation.

### Advantageous Effects of Invention

According to the present disclosure, it is possible to evaluate conformity to a legal system by criterion evaluation and evaluate by means evaluation whether or not anonymization-processed data is certainly processed in an anonymization-processing means subject to the evaluation.

### BRIEF DESCRIPTION OF DRAWINGS

FIG. 1 is a configuration diagram of an anonymization-processing evaluation system 100S and an anonymization-processing evaluation apparatus 100 according to a first embodiment.

FIG. 2 is a flow chart of an anonymization-processing evaluation method according to the first embodiment.

FIG. 3 is a diagram illustrating personal information data 191 according to the first embodiment.

FIG. 4 is a diagram illustrating anonymization-processed data 192 according to the first embodiment.

FIG. 5 is a diagram illustrating anonymization-processing means data 193 according to the first embodiment.

FIG. 6 is a flowchart of means evaluation (S120) according to the first embodiment.

FIG. 7 is a diagram illustrating criterion determination data 194 according to the first embodiment.

FIG. 8 is a flowchart of criterion evaluation (S130) according to the first embodiment.

FIG. 9 is the flowchart of the criterion evaluation (S130) according to the first embodiment.

FIG. 10 is a flowchart of result output (S140) according to the first embodiment.

FIG. 11 is a diagram illustrating an evaluation screen 195 according to the first embodiment.

FIG. 12 is a configuration diagram of an anonymization-processing evaluation apparatus 100 according to a second embodiment.

FIG. 13 is a flowchart of an anonymization-processing evaluation method according to the second embodiment.

FIG. 14 is a diagram illustrating an anonymization-processing program 196 according to the second embodiment.

FIG. 15 is a diagram illustrating anonymization-processing code data 197 according to the second embodiment.

FIG. 16 is a flowchart of a program analysis (S220) according to the second embodiment.

FIG. 17 is a diagram illustrating anonymization-processing means data 198 according to the second embodiment.

FIG. 18 is a hardware configuration diagram of the anonymization-processing evaluation apparatus 100 according to the embodiment.

### DESCRIPTION OF EMBODIMENTS

In descriptions of the embodiments and the drawings, the same reference numerals are assigned to the same elements or corresponding elements. Descriptions of elements assigned with the same reference numerals as the described elements will be omitted or simplified as appropriate. Arrows in the drawings mainly indicate flows of data or flows of processes.

### First Embodiment

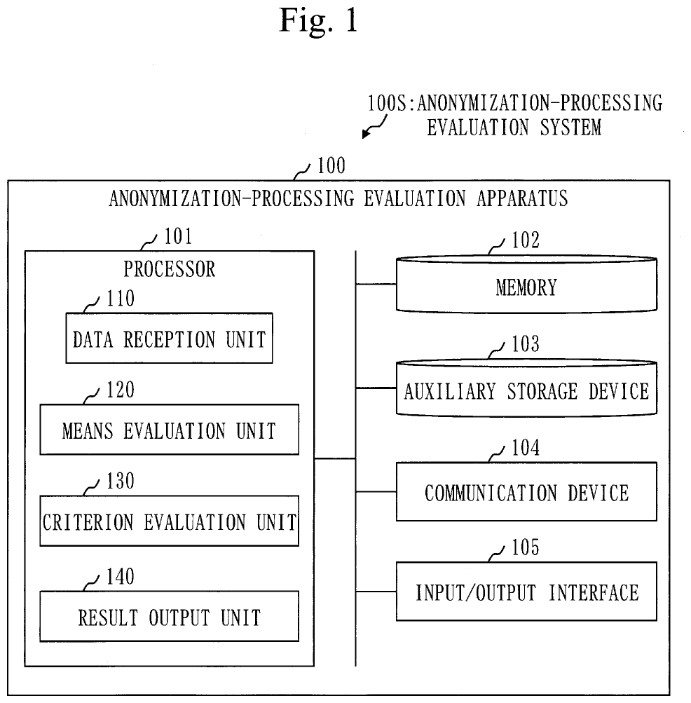

An anonymization-processing evaluation system 100S will be described with reference to FIGS. 1 to 11.

Description of Configuration

With reference to FIG. 1, a configuration of the anonymization-processing evaluation system 100S and an anonymization-processing evaluation apparatus 100 will be described.

The anonymization-processing evaluation system 100S includes the anonymization-processing evaluation apparatus 100. Note that, the anonymization-processing evaluation apparatus 100 may be realized by two or more apparatuses (computers).

The anonymization-processing evaluation apparatus 100 is a computer which includes pieces of hardware such a processor 101, a memory 102, an auxiliary storage device 103, a communication device 104, and an input/output interface 105. These pieces of hardware are connected to each other via signal lines.

The processor 101 is an IC which performs a calculation process, and controls other pieces of hardware. For example, the processor 101 is a CPU, a DSP, or a GPU.

IC stands for Integrated Circuit.

CPU stands for Central Processing Unit.

DSP stands for Digital Signal Processor.

GPU stands for Graphics Processing Unit.

The memory 102 is a volatile or non-volatile storage device. The memory 102 is referred to as a main storage device or a main memory. For example, the memory 102 is a RAM. Data stored in the memory 102 is stored in the auxiliary storage device 103 as necessary.

RAM stands for Random Access Memory.

The auxiliary storage device 103 is a non-volatile storage device. For example, the auxiliary storage device 103 is a ROM, an HDD, or a flash memory. Data stored in the auxiliary storage device 103 is loaded into the memory 102 as necessary.

ROM stands for Read Only Memory.

HDD stands for Hard Disk Drive.

The communication device 104 is a receiver and a transmitter. For example, the communication device 104 is a communication chip or an NIC.

NIC stands for Network Interface Card.

The input/output interface 105 is a port to which an input device and an output device are connected. For example, the input/output interface 105 is a USB terminal, the input device is a keyboard or a mouse, and the output device is a display.

USB stands for Universal Serial Bus.

The anonymization-processing evaluation apparatus 100 includes elements such as a data reception unit 110, a means evaluation unit 120, a criterion evaluation unit 130, and a result output unit 140. These elements are realized by software.

The auxiliary storage device 103 stores an anonymization-processing evaluation program for causing a computer to function as the data reception unit 110, the means evaluation unit 120, the criterion evaluation unit 130, and the result output unit 140. The anonymization-processing evaluation program is loaded into the memory 102, and executed by the processor 101.

The auxiliary storage device 103 further stores an OS. At least a part of the OS is loaded into the memory 102, and executed by the processor 101.

The processor 101 executes the anonymization-processing evaluation program while executing the OS.

OS stands for Operating System.

Input/output data of the anonymization-processing evaluation program is stored in a storage device such as the memory 102, the auxiliary storage device 103, a register in the processor 101 or a cash memory in the processor 101. The storage device is also called a storage unit.

The anonymization-processing evaluation apparatus 100 may include a plurality of processors which substitute for the processor 101. The plurality of processors share a function of the processor 101.

The anonymization-processing evaluation program can be recorded (stored) in a non-volatile recording medium such as an optical disc or a flash memory in a computer-readable manner.

Description of Operation

A procedure of operation of the anonymization-processing evaluation system 100S is equivalent to an anonymization-processing evaluation method. Also, a procedure of operation of the anonymization-processing evaluation apparatus 100 is equivalent to a procedure of a process by the anonymization-processing evaluation program.

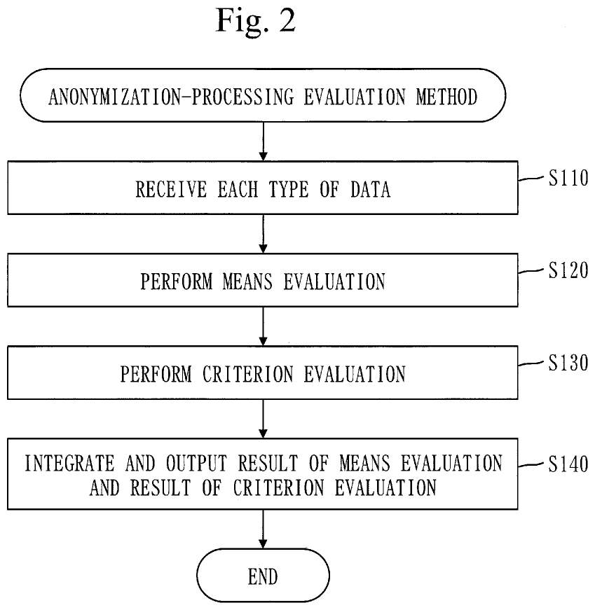

With reference to FIG. 2, the anonymization-processing evaluation method will be described.

In step S110, the data reception unit 110 receives personal information data, anonymization-processed data, and means-specifying data.

Then, the data reception unit 110 stores each received data in the auxiliary storage device 103.

The personal information data is data indicating personal information. There is no limitation to a format of the personal information data and a data form of the personal information data.

The personal information includes one or more attributes which specify an individual. For example, the personal information includes an attribute such as a name or age.

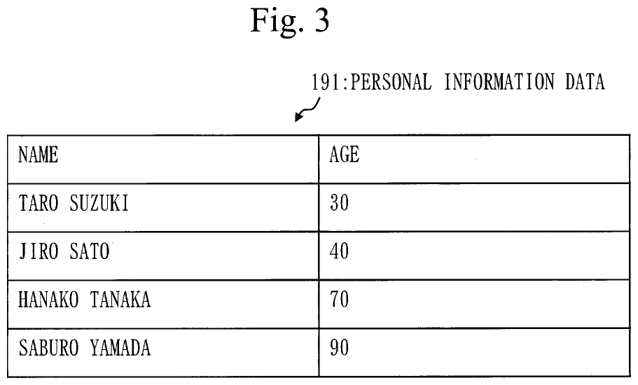

FIG. 3 illustrates personal information data 191. The personal information data 191 is an example of the personal information data.

The personal information data 191 indicates four pieces of personal information. Each piece of personal information includes a name and age.

For example, the first personal information includes a name of “Taro Suzuki” and age of “30 years old”.

Next, anonymization-processed data will be described.

The anonymization-processed data is data indicating anonymization-processed personal information. There is no limitation to a format of the anonymization-processed data and a data form of the anonymization-processed data.

The anonymization processing is processing for anonymizing the personal information.

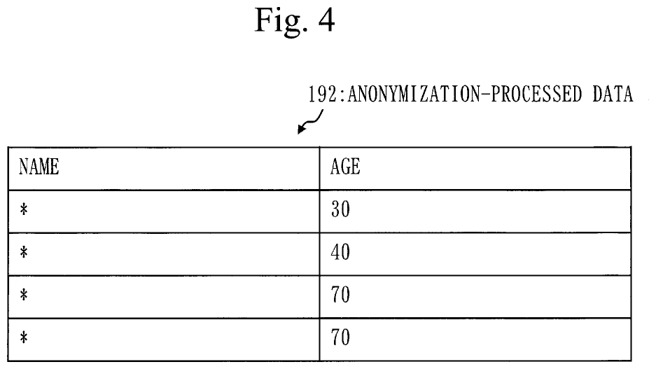

FIG. 4 illustrates anonymization-processed data 192. The anonymization-processed data 192 is an example of the anonymization-processed data.

The anonymization-processed data 192 indicates four pieces of anonymization-processed personal information. Each piece of personal information includes a name and age.

For example, the first personal information includes a name of “*” and age of “30 years old”. That is, the name in the personal information is deleted by being overwritten with “*”.

Next, the means-specifying data will be described.

The means-specifying data is data for specifying an anonymization-processing rule for the personal information. Specific means-specifying data is anonymization-processing means data.

The anonymization-processing means data indicates the anonymization-processing rule. There is no limitation to a format of the anonymization-processing means data and a data form of the anonymization-processing means data.

The anonymization-processing rule is a rule for anonymizing the personal information by a specific anonymization-processing method.

For example, the anonymization-processing rule is defined by the anonymization-processing method, a subject attribute of the anonymization-processing method, and a parameter of the anonymization-processing method. The subject attribute of the anonymization-processing method is an attribute subject to the processing by the anonymization-processing method.

The anonymization-processing method is a method of the processing which is for anonymization.

For example, the anonymization-processing method is deletion, top-coding, Microaggregation, or the like.

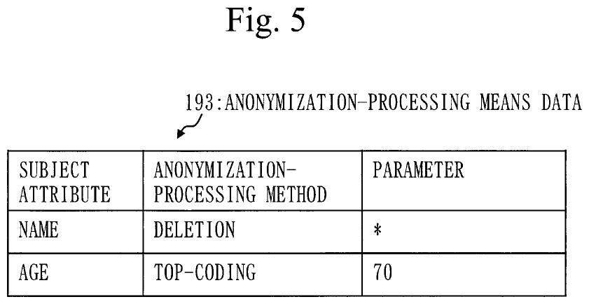

FIG. 5 illustrates anonymization-processing means data 193. The anonymization-processing means data 193 is an example of the anonymization-processing means data.

The anonymization-processing means data 193 indicates two anonymization-processing rules. Each anonymization-processing rule is defined by the subject attribute, the anonymization-processing method, and the parameter.

The first anonymization-processing rule is “subject attribute=“name”, anonymization-processing method=“deletion”, parameter=“*””, and determines the anonymization processing which is “delete a name by overwriting with “*””.

The second anonymization-processing rule is “subject attribute=“age”, anonymization-processing method=“top-coding”, parameter=“70””, and determines the anonymization processing which is “top-code age by setting 70 years old as an upper limit”.

Returning to FIG. 2, step S120 will be described.

In step S120, the means evaluation unit 120 performs means evaluation based on the personal information data and the anonymization-processed data.

In the means evaluation, the means evaluation unit 120 determines whether or not conversion from the personal information into the anonymization-processed personal information is performed by applying the anonymization-processing rule specified by the means-specifying data.

Specific means-specifying data is the anonymization-processing means data. That is, the means evaluation unit 120 performs the means evaluation on the anonymization-processing rule indicated in the anonymization-processing means data.

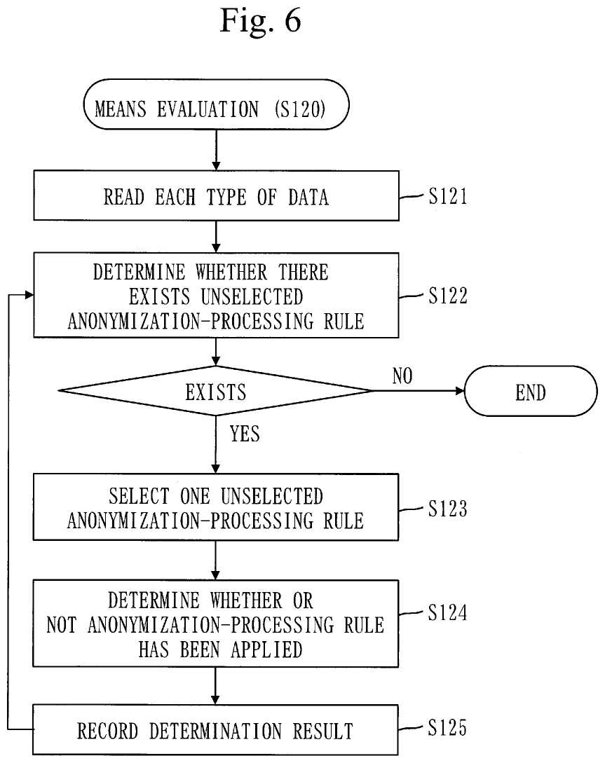

With reference to FIG. 6, a procedure of the means evaluation (S120) will be described.

In step S121, the means evaluation unit 120 reads the personal information data and the anonymization-processed data into the memory 102.

In step S122, the means evaluation unit 120 determines whether or not there is an anonymization-processing rule which has not been selected (unselected anonymization-processing rule), in the anonymization-processing means data.

If there is the unselected anonymization-processing rule, the process proceeds to step S123.

If there is no unselected anonymization-processing rule, the process ends.

In step S123, the means evaluation unit 120 selects one unselected anonymization-processing rule from the anonymization-processing means data, and reads the selected anonymization-processing rule into the memory 102.

Specifically, the means evaluation unit 120 selects from the anonymization-processing means data, the i-th anonymization-processing rule as the i-th. “i” is an integer equal to or larger than one.

For example, the means evaluation unit 120 selects from the anonymization-processing means data 193 (see FIG. 5), the first anonymization-processing rule “subject attribute=“name”, anonymization-processing method=“deletion”, parameter=“*”” as the first. Further, the means evaluation unit 120 selects from the anonymization-processing means data 193, the second anonymization-processing rule “subject attribute=“age”, anonymization-processing method=“top-coding”, parameter=“70”” as the second.

The anonymization-processing rule selected as the i-th in step S123 is referred to as an anonymization-processing rule (i).

In step S124, the means evaluation unit 120 determines whether or not the anonymization-processing rule (i) has been applied between the personal information data and the anonymization-processed data.

For example, the means evaluation unit 120 processes the personal information data following the anonymization-processing rule (i). Then, the means evaluation unit 120 compares the subject attribute in the processed personal information data with the subject attribute in the anonymization-processed data. If the subject attribute in the processed personal information data is the same as the subject attribute in the anonymization-processed data, the anonymization-processing rule (i) has been applied.

The first anonymization-processing rule in the anonymization-processing means data 193 (see FIG. 5) is “subject attribute=“name”, anonymization-processing method=“deletion”, parameter=“*””. When the first anonymization-processing rule in the anonymization-processing means data 193 is applied to the personal information data 191 (see FIG. 3), each name in the processed personal information data 191 is “*”. On the other hand, each name in the anonymization-processed data 192 (see FIG. 4) is “*”. That is, the subject attribute (name) in the processed personal information data 191 is the same as the subject attribute (name) in the anonymization-processed data 192. Therefore, the first anonymization-processing rule in the anonymization-processing means data 193 has been applied between the personal information data 191 and the anonymization-processed data 192.

The second anonymization-processing rule in the anonymization-processing means data 193 (see FIG. 5) is “subject attribute=“age”, anonymization-processing method=“top-coding”, parameter=“70””. When the second anonymization-processing rule in the anonymization-processing means data 193 is applied to the personal information data 191 (see FIG. 3), age in the processed personal information data 191 is “30, 40, 70, and 70”. On the other hand, age in the anonymization-processed data 192 is “30, 40, 70, and 70”. That is, the subject attribute (age) in the processed personal information data 191 is the same as the subject attribute (age) in the anonymization-processed data 192 (see FIG. 4). Therefore, the second anonymization-processing rule in the anonymization-processing means data 193 has been applied between the personal information data 191 and the anonymization-processed data 192.

In step S125, the means evaluation unit 120 records a determination result (i).

The determination result (i) indicates whether or not the anonymization-processing rule (i) has been applied between the personal information data and the anonymization-processed data.

For example, the means evaluation unit 120 stores empty means evaluation data in the auxiliary storage device 103 at a time of starting the means evaluation (S120). Then, the means evaluation unit 120 registers the determination result (i) in the means evaluation data.

After step S125, the process proceeds to step S122.

Returning to FIG. 2, step S130 will be descried.

In step S130, the criterion evaluation unit 130 performs criterion evaluation based on criterion determination data.

The criterion determination data is data indicating one or more criteria determination rules for one or more anonymization-processing criteria. There is no limitation to a format of the criterion determination data and a data form of the criterion determination data. The criterion determination data is stored in the auxiliary storage device 103 in advance.

The anonymization-processing criterion is a criterion decided by a regulation for the anonymization processing.

Specifically, the anonymization-processing criterion is a criterion decided by the legal system for the anonymization processing. Specific examples of the legal system are the Act on the Protection of Personal Information (revised by Act No. 57 of 2003, Act No. 65 of 2015, and Act No. 51 of 2016) and Enforcement Rules for the Act on the Protection of Personal Information (Rules of the Personal Information Protection Commission No. 3 of 2016) which are in Japan.

A criterion determination rule is a rule for determining the anonymization-processing criterion.

For example, the criterion determination rule is defined by the subject attribute, the anonymization-processing method, and an applicable criterion. The applicable criterion is the anonymization-processing criterion to which the anonymization-processing rule specified by a set of the subject attribute and the anonymization-processing method is applicable.

In the criterion evaluation, the criterion evaluation unit 130 determines the anonymization-processing criterion for the criterion determination rule which is the same as the anonymization-processing rule specified by the means-specifying data.

Specific means-specifying data is the anonymization-processing means data. That is, the criterion evaluation unit 130 performs the criterion evaluation on the anonymization-processing rule indicated in the anonymization-processing means data.

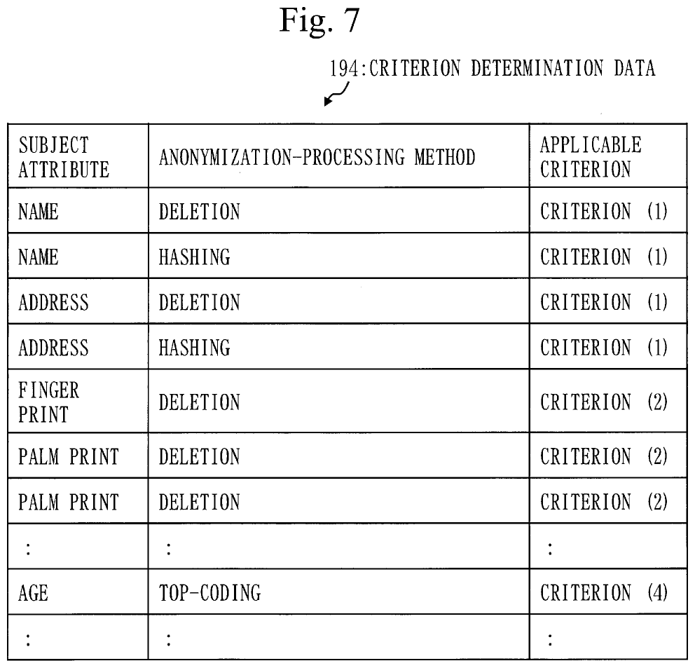

FIG. 7 illustrates criterion determination data 194. The criterion determination data 194 is an example of the criterion determination data.

The criterion determination data 194 indicates a plurality of criterion determination rules. Each criterion determination rule is defined by the subject attribute, the anonymization-processing method, and the applicable criterion.

For example, the first criterion determination rule is “subject attribute=“name”, anonymization-processing method=“deletion”, applicable criterion=“criterion (1)”, and determines that the anonymization processing which is “delete a name” is applicable to the criterion (1).

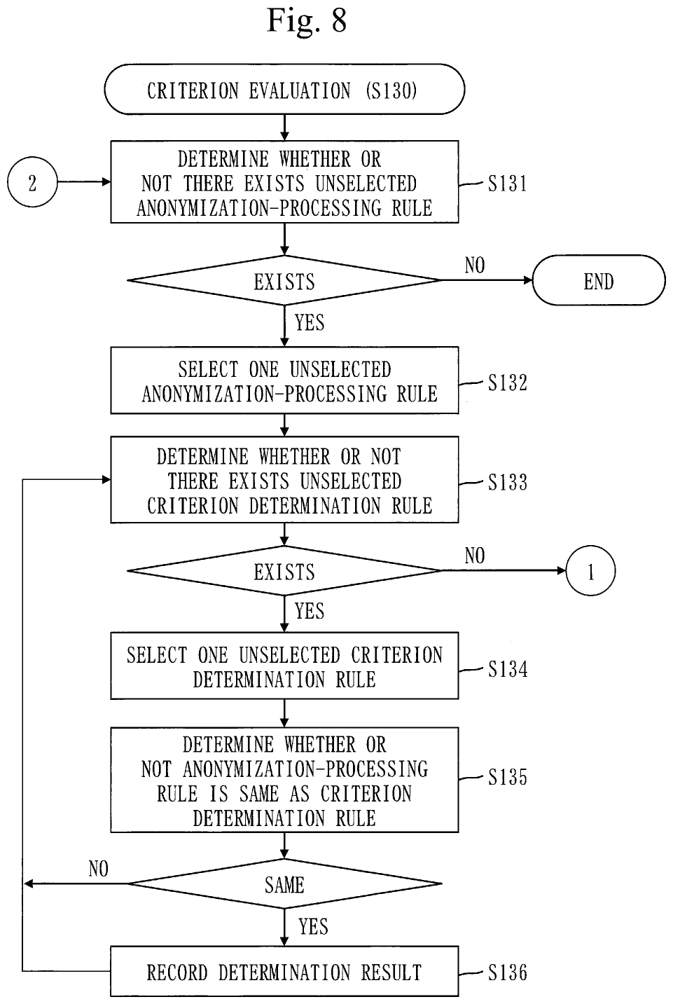

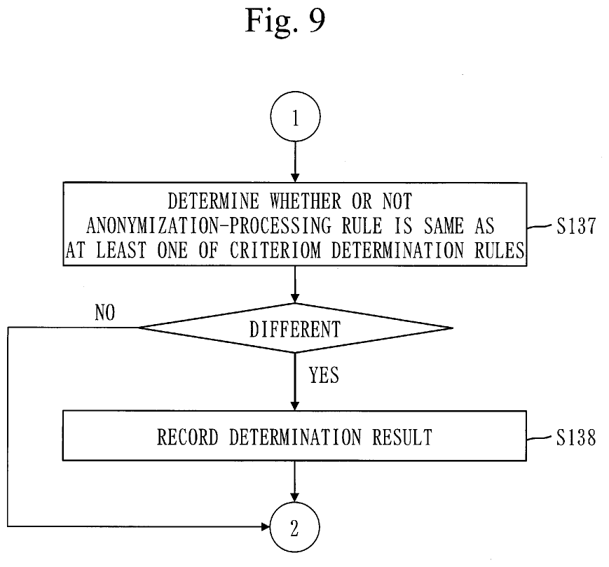

With reference to FIGS. 8 and 9, a procedure of the criterion evaluation (S130) will be described.

In step S131, the criterion evaluation unit 130 determines whether or not there is an anonymization-processing rule which has not been selected (unselected anonymization-processing rule), in the anonymization-processing means data.

When there is the unselected anonymization-processing rule, the process proceeds to step S132.

When there is no anonymization-processing rule, the process ends.

In step S132, the criterion evaluation unit 130 selects one unselected anonymization-processing rule from the anonymization-processing means data, and reads the selected anonymization-processing rule into the memory 102.

Specifically, the criterion evaluation unit 130 selects from the anonymization-processing means data, the i-th anonymization-processing rule as the i-th. “i” is an integer equal to or larger than 1.

The anonymization-processing rule selected as the i-th in step S132 is referred to as an anonymization-processing rule (i).

In step S133, the criterion evaluation unit 130 determines whether or not in the criterion determination data, there is a criterion determination rule which has not been selected (unselected criterion determination rule) for the anonymization-processing rule (i).

When there is the unselected criterion determination rule, the process proceeds to step S134.

When there is no unselected criterion determination rule, the process proceeds to step S137.

In step S134, the criterion evaluation unit 130 selects from the criterion determination data, one unselected criterion determination rule for the anonymization-processing rule (i), and reads the selected criterion determination rule into the memory 102.

Specifically, the criterion evaluation unit 130 selects from the criterion determination data, the j-th criterion determination rule as the j-th. “j” is an integer equal to or larger than one.

The criterion determination rule selected as the j-th in step S134 is referred to as a criterion determination rule (j).

In step S135, the criterion evaluation unit 130 compares the anonymization-processing rule (i) with the anonymization-processing rule indicated in the criterion determination rule (j).

Then, the criterion evaluation unit 130 determines based on the comparison result, whether or not the anonymization-processing rule (i) is the same as the anonymization-processing rule indicated in the criterion determination rule (j).

Specifically, the criterion evaluation unit 130 determines whether or not a set of the subject attribute and the anonymization-processing method in the anonymization-processing rule (i) is the same as a set of the subject attribute and the anonymization-processing method in the criterion determination rule (j).

For example, in the first anonymization-processing rule in the anonymization-processing means data 193 (see FIG. 5), the set of the subject attribute and the anonymization-processing method is (name and deletion). Further, in the first criterion determination rule in the criterion determination data 194 (see FIG. 7), the set of the subject attribute and the anonymization-processing method is (name and deletion). That is, the set in the first anonymization-processing rule is the same as the set in the first criterion determination rule. Therefore, the first anonymization-processing rule in the anonymization-processing means data 193 is the same as the anonymization-processing rule indicated in the first criterion determination rule.

If the anonymization-processing rule (i) is the same as the anonymization-processing rule indicated in the criterion determination rule (j), the process proceeds to step S136.

If the anonymization-processing rule (i) is not the same as the anonymization-processing rule indicated in the criterion determination rule (j), the process proceeds to step S133.

In step S136, the criterion evaluation unit 130 records a determination result (i, j).

The determination result (i, j) indicates that the anonymization-processing rule (i) conforms to a criterion (j).

The criterion (j) is the applicable criterion indicated in the criterion determination rule (j).

For example, the criterion evaluation unit 130 stores empty criterion evaluation data in the auxiliary storage device 103 at a time of starting the criterion evaluation (S130). Then, the criterion evaluation unit 130 registers the determination result (i, j) in the criterion evaluation data.

In step S137, the criterion evaluation unit 130 determines based on the determination result in step S135, whether or not the anonymization-processing rule (i) is the same as the anonymization-processing rule indicated in at least one of the criterion determination rules (j).

For example, the criterion evaluation unit 130 determines whether or not the determination result (i, j) is registered in the criterion evaluation data. If at least one of the determination results (i, j) is registered in the criterion evaluation data, the anonymization-processing rule (i) is the same as the anonymization-processing rule indicated in at least one of the criterion determination rules (j).

If the anonymization-processing rule (i) is not the same as at least one of the criterion determination rules (j), the process proceeds to step S138.

If the anonymization-processing rule (i) is the same as at least one of the criterion determination rules (j), the process proceeds to step S131.

In step S138, the criterion evaluation unit 130 records a determination result (i).

The determination result (i) indicates that the anonymization-processing rule (i) does not conform to any criterion (j).

For example, the criterion evaluation unit 130 registers the determination result (i) in the criterion evaluation data.

After step S138, the process proceeds to step S131.

Returning to FIG. 2, step S140 will be described.

In step S140, the result output unit 140 integrates the result of the means evaluation (S120) and the result of the criterion evaluation (S130). Data obtained by the integration is referred to as “integrated-evaluation data”.

Then, the result output unit 140 outputs the integrated-evaluation data. Specifically, the result output unit 140 displays the integrated-evaluation data on the display.

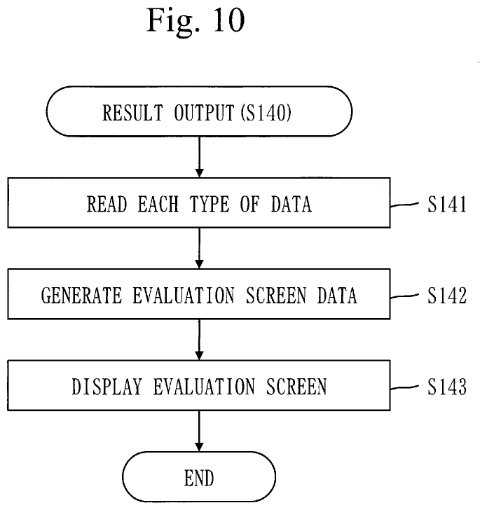

With reference to FIG. 10, a procedure of result output (S140) will be described.

In step S141, the result output unit 140 reads the personal information data, the anonymization-processed data, the anonymization-processing means data, the means evaluation data, and the criterion evaluation data into the memory 102.

In step S142, the result output unit 140 generates evaluation screen data by using the read pieces of data.

The evaluation screen data is data equivalent to the integrated-evaluation data, and presents an evaluation screen.

The evaluation screen is a screen which shows details of read pieces of data.

In step S143, the result output unit 140 shows the evaluation screen on the display by using the evaluation screen data.

Specifically, the result output unit 140 shows the evaluation screen on the display by inputting the evaluation screen data into the display.

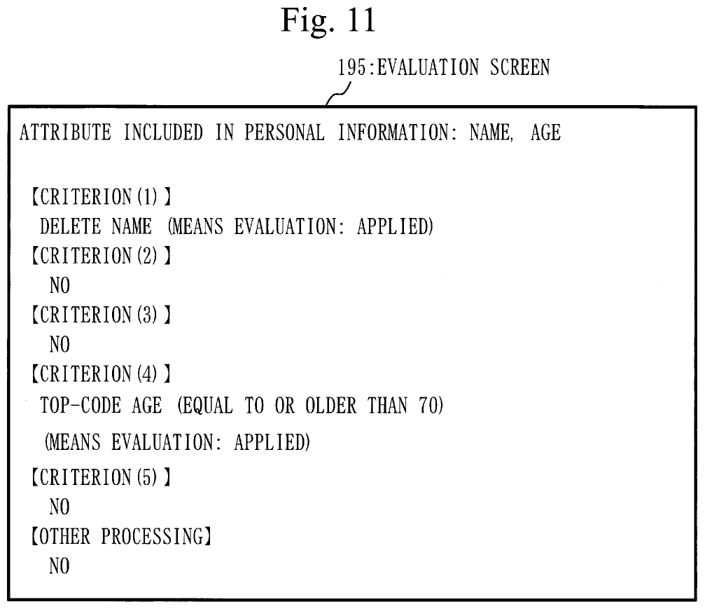

FIG. 11 illustrates an evaluation screen 195. The evaluation screen 195 is an example of the evaluation screen.

The evaluation screen 195 shows attributes (name and age) included in the personal information.

The evaluation screen 195 shows the anonymization-processing rule which conforms to the criterion (1). Further, the evaluation screen 195 shows that the anonymization-processing rule which conforms to the criterion (1) has been applied to the personal information.

The evaluation screen 195 shows the anonymization-processing rule which conforms to the criterion (4). Further, the evaluation screen 195 shows that the anonymization-processing rule which conforms to the criterion (4) has been applied to the personal information.

### DESCRIPTION OF EXAMPLES

Each piece of data does not have to be input/output via the auxiliary storage device 103 between the elements such as the data reception unit 110, the means evaluation unit 120, the criterion evaluation unit 130, and the result output unit 140. For example, each piece of data may be shared by the memory 102, or each piece of data may be transmitted/received between the elements.

The result output unit 140 may execute an evaluation function by inputting the result of the means evaluation (S120) and the result of the criterion evaluation (S130), and include an evaluation value in the integrated-evaluation data. The evaluation function is prepared in advance.

### Effect of First Embodiment

According to the first embodiment, the evaluation result for the legal system criterion is shown on the screen together with the evaluation result indicating that the anonymization-processed data is certainly generated according to the anonymization-processing rule. Therefore, a person that evaluates the anonymization-processing means can easily determine whether or not the input anonymization-processing means satisfies the legal system criterion, by viewing the screen.

### Second Embodiment

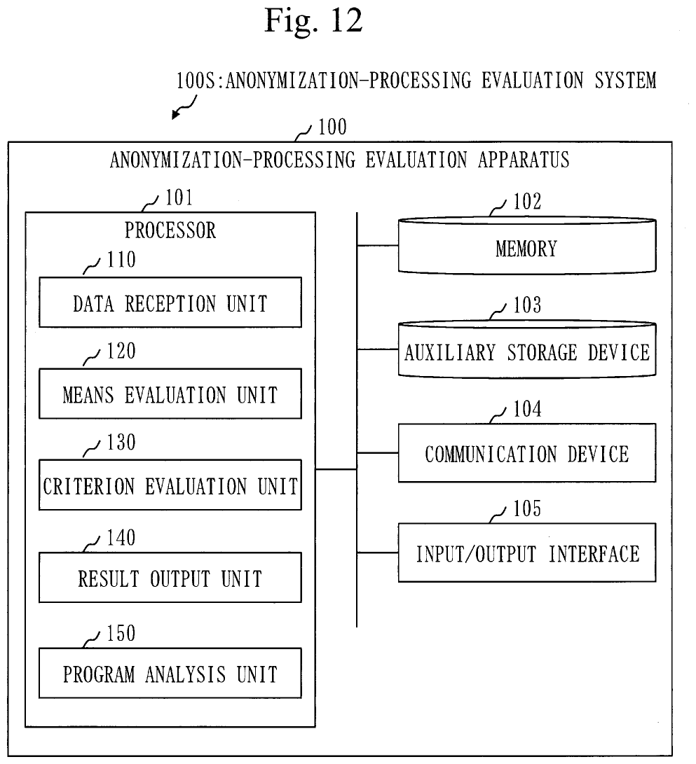

As to a mode of specifying the anonymization-processing rule by analyzing a program for the anonymization processing, mainly matters different from the first embodiment will be described with reference to FIGS. 12 to 17.

***Description of Configuration***

With reference to FIG. 12, a configuration of the anonymization-processing evaluation apparatus 100 will be described.

The anonymization-processing evaluation apparatus 100 further includes a program analysis unit 150.

The anonymization-processing evaluation program further causes a computer to function as the program analysis unit 150.

***Description of Operation***

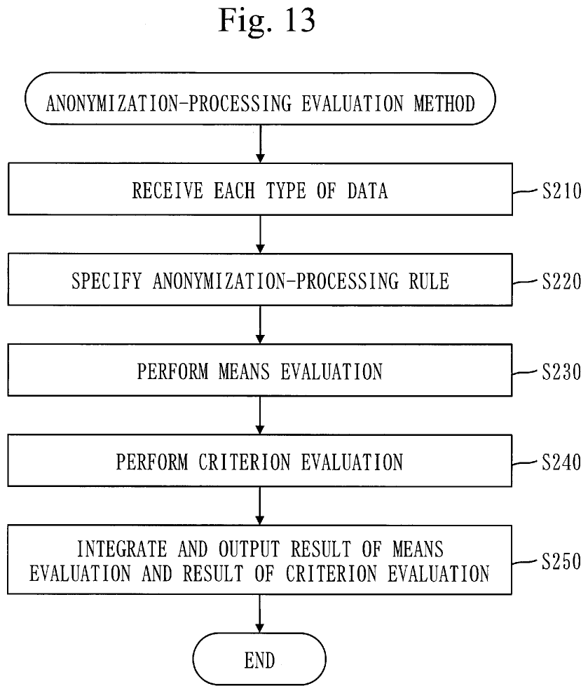

With reference to FIG. 13, an anonymization-processing evaluation method will be described.

In step S210, the data reception unit 110 receives the personal information data, the anonymization-processed data, and the means-specifying data, and stores each received pieces of data in the auxiliary storage device 103. However, the means-specifying data is an anonymization-processing program.

The anonymization-processing program is a program for performing the anonymization processing according to a specific anonymization-processing rule.

That is, in the anonymization-processing program, a procedure of a process for performing the anonymization processing according to the specific anonymization-processing rule is written.

There is no limitation to a format of the anonymization-processing program and a form of the anonymization-processing program.

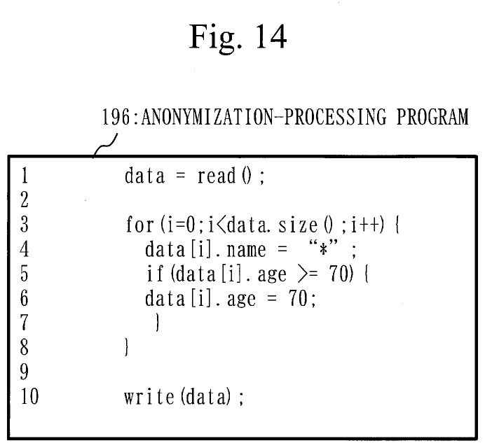

FIG. 14 illustrates an anonymization-processing program 196. The anonymization-processing program 196 is an example of the anonymization-processing program.

The anonymization-processing program 196 is a source program written in a programming language C++.

A function “read ( )” is a function for reading into the memory 102, the personal information data stored in the auxiliary storage device 103.

A function “write( )” is a function for writing into the auxiliary storage device 103, the anonymization-processed data stored in the memory 102.

The function “read( )” and the function “write( )” are implemented separately from the anonymization-processing program 196.

An array “data” is an array for the personal information, and each element of the array “data” has a member “name” for the name and a member “age” for the age.

First, on the first line, the personal information data is read from the auxiliary storage device 103 into the memory 102 by the “read( )”. Then, the name of each personal information is stored in the member “name” of each element of the array “data”, and the age of each personal information is stored in the member “age” of each element of the array “data”.

Next, on the third to the eighth lines, the anonymization processing is performed on each personal information stored in the array “data”. Thereby, the anonymization-processed data is stored in the array “data”.

Finally, on the tenth line, the anonymization-processed data is written from the memory 102 into the auxiliary storage device 103 by “write(data)”.

Returning to FIG. 13, step S220 will be described.

In step S220, the program analysis unit 150 specifies by analyzing the anonymization-processing program, the anonymization-processing rule realized by the anonymization-processing program.

Specifically, the program analysis unit 150 uses anonymization-processing code data and specifies the anonymization-processing rule.

The anonymization-processing code data is data indicating one or more abstraction codes corresponding to one or more abstraction rules. The anonymization-processing code data is stored in the auxiliary storage device 103 in advance.

The abstraction rule is an abstracted anonymization-processing rule, and includes one or more abstracted elements (abstraction elements).

The abstraction code is an abstracted program code, and includes one or more abstracted elements (abstraction elements).

The program code is one or more commands in a program.

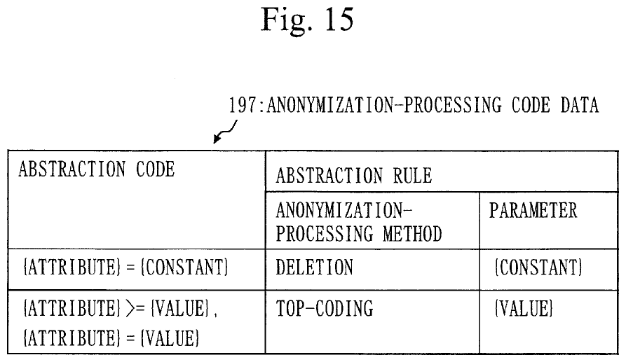

FIG. 15 illustrates anonymization-processing code data 197. The anonymization-processing code data 197 is an example of the anonymization-processing code data.

The anonymization-processing code data 197 indicates two abstraction codes corresponding to two abstraction rules. The abstraction rule is indicated by a set of the anonymization-processing method and the parameter.

The first abstraction code is “{attribute}={constant}”. Each of {attribute} and {constant} is the abstraction element.

The first abstraction rule is “anonymization-processing method=deletion, parameter={constant}”. {constant} is the abstraction element.

The second abstraction code is “{attribute}>={value}, {attribute}={value}”. Each of {value} and {attribute} is the abstraction element.

The second abstraction rule is “anonymization-processing method=top-coding, parameter={value}”. {value} is the abstraction element.

A variable storing the attribute of the personal information is referred to as “attribute variable”.

The first abstraction code means that a constant is substituted for the attribute variable. The first abstraction rule means that the attribute of the personal information is deleted by being overwritten with the constant.

The second abstraction rule means that a specific value is substituted for the attribute variable after the attribute variable is compared with the specific value. The second abstraction rule means the top-coding which sets the specific value as an upper limit.

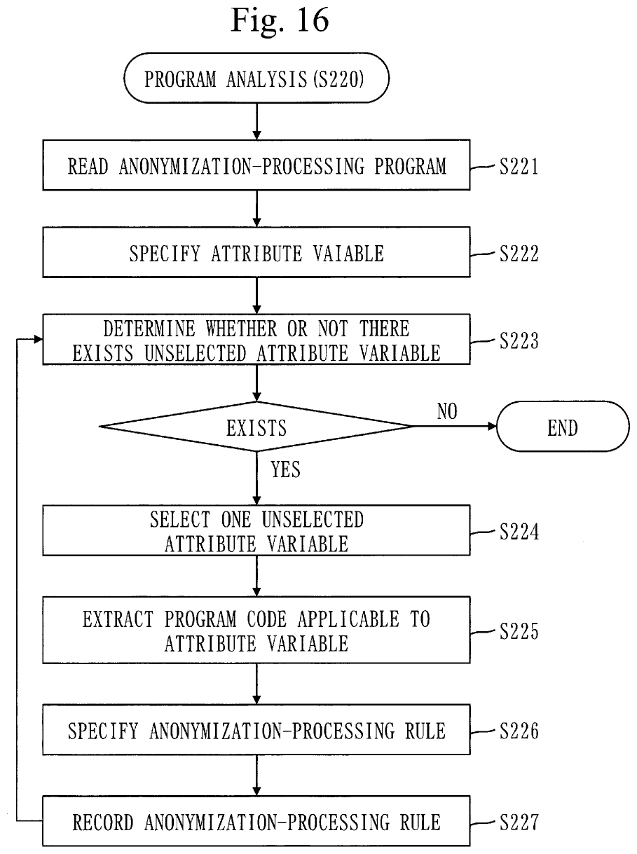

With reference to FIG. 16, a procedure of a program analysis (S220) will be described.

In step S221, the program analysis unit 150 reads the anonymization-processing program from the auxiliary storage device 103 into the memory 102.

In step S222, the program analysis unit 150 specifies a variable (attribute variable) which stores each attribute of the personal information, by analyzing the anonymization-processing program.

In the anonymization-processing program 196 (see FIG. 14), “name” is the attribute variable storing the name, and “age” is the attribute variable storing the age.

For example, the attribute variable is specified as follows.

In the personal information data, a tag is added to each attribute. Each tag identifies the attribute. For example, an attribute name is added to each attribute in such a way of, for example, “name: Ichiro Suzuki, age: 30 years old”. The program analysis unit 150 records the value stored in each variable while executing the anonymization-processing program. Then, the program analysis unit 150 specifies the attribute variable based on the value stored in each variable. For example, values such as “Ichiro Suzuki”, “Jiro Sato”, and “Hanako Tanaka” are stored in a variable “name”. In the personal information data, tags “name” are added to the values such as “Ichiro Suzuki”, “Jiro Sato”, and “Hanako Tanaka”. Therefore, the program analysis unit 150 specifies that the variable “name” is the attribute variable for the name.

In step S223, the program analysis unit 150 determines whether or not there is an attribute variable which has not been selected (unselected attribute variable), in one or more specified attribute variables.

When there is the unselected attribute variable, the process proceeds to step S224.

When there is no unselected attribute variable, the process ends.

In step S224, the program analysis unit 150 selects one unselected attribute variable.

In step S225, the program analysis unit 150 extracts from the analysis-processing program, a program code including the selected attribute variable.

For example, when the selected attribute variable is the “age”, “age>=70, age=70” is extracted from the anonymization-processing program 196 (see FIG. 14).

In step S226, the program analysis unit 150 specifies an anonymization-processing rule corresponding to the extracted program code.

The anonymization-processing rule is specified as follows.

First, the program analysis unit 150 searches for an abstraction code applicable to the extracted program code by using the anonymization-processing code data. The abstraction code applicable to the extracted program code is referred to as “applicable abstraction code”.

Next, the program analysis unit 150 acquires from the anonymization-processing code data, an abstraction rule for the applicable abstraction code. The abstraction rule for the applicable abstraction code is referred to as “applicable abstraction rule”.

Next, for each abstraction element of the applicable abstraction code and the applicable abstraction rule, the program analysis unit 150 extracts an element applicable to the abstraction element from the extracted program code.

Then, the program analysis unit 150 generates the anonymization-processing rule by using the element applicable to each abstraction element.

For example, the extracted program code is “age>=70, age=70”. “age>70, age=70” is applicable to the second abstraction code “{attribute}>={value}, {attribute}={value}” of the anonymization-processing code data 197 (see FIG. 15). The abstraction rule applicable to this abstraction code is “anonymization-processing method=top-coding, parameter={value}”. {attribute} in the extracted program code is age. “age” is the attribute variable for the age. {value} in the extracted program code is “70”. Therefore, the program analysis unit 150 generates the anonymization-processing rule which is “subject attribute=age, anonymization-processing method=top-coding, parameter=70”.

In step S227, the program analysis unit 150 records the specified anonymization-processing rule.

Specifically, the program analysis unit 150 stores empty anonymization-processing means data in the auxiliary storage device 103 at a time of starting the program analysis (S220). Then, the program analysis unit 150 registers a set of the subject attribute, the anonymization-processing method, and the parameter in the anonymization-processing means data.

After step S227, the process proceeds to step S223.

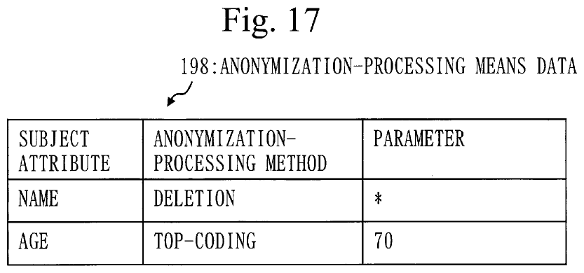

FIG. 17 illustrates anonymization-processing means data 198. The anonymization-processing means data 198 is an example of the anonymization-processing means data.

The anonymization-processing means data 198 is generated by using the anonymization-processing program 196 (see FIG. 14) and the anonymization-processing code data 197 (see FIG. 15).

Details of the anonymization-processing means data 198 are the same as those in the anonymization-processing means data 193 in the first embodiment (see FIG. 5).

Returning to FIG. 13, a process of step S230 and processes after step S230 will be described.

Steps S230 to S250 are the same as steps S120 to S140 in the first embodiment (see FIG. 2).

However, instead of the anonymization-processing means data received in step S110, the anonymization-processing means data generated in step S220 is used.

### Effect of Second Embodiment

According to the second embodiment, the anonymization-processing rule is specified by analyzing the anonymization-processing program. Therefore, a user can acquire the evaluation result without preparing the anonymization-processing means data.

### Supplement to Embodiments

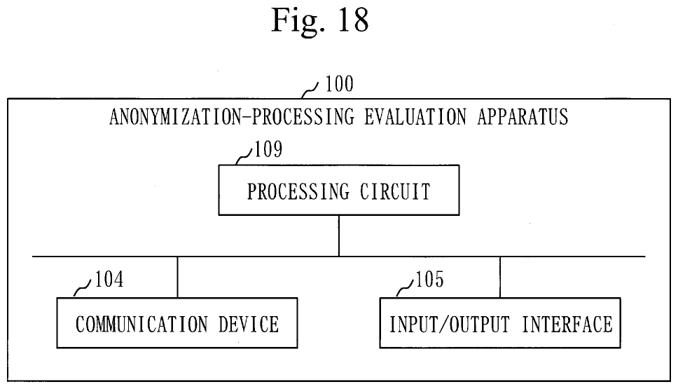

With reference to FIG. 18, a hardware configuration of the anonymization-processing evaluation apparatus 100 will be described.

The anonymization-processing evaluation apparatus 100 includes processing circuitry 109.

The processing circuitry 109 is hardware which realizes the data reception unit 110, the means evaluation unit 120, the criterion evaluation unit 130, the result output unit 140, and the program analysis unit 150.

The processing circuitry 109 may be dedicated hardware, or may be the processor 101 which executes a program stored in the memory 102.

When the processing circuitry 109 is the dedicated hardware, the processing circuitry 109 is, for example, a single circuit, a composite circuit, a programmed processor, a parallel-programmed processor, an ASIC, an FPGA, or a combination of these.

ASIC stands for Application Specific Integrated Circuit.

FPGA stands for Field Programmable Gate Array.

The anonymization-processing evaluation apparatus 100 may include a plurality of processing circuits which substitute for the processing circuitry 109. The plurality of processing circuits share a function of the processing circuitry 109.

In the processing circuitry 109, a part of the function may be realized by the dedicated hardware, and the rest of the function may be realized by software or firmware.

As described above, the function of the anonymization-processing evaluation apparatus 100 can be realized by hardware, software, firmware, or a combination of these.

Each embodiment is an example of a preferred mode, and is not intended to limit the technical scope of the present disclosure. Each embodiment may be implemented partially or may be implemented being combined with other modes. The procedures described using the flowcharts and the like may be changed as appropriate.

“Unit” which is an element of the anonymization-processing evaluation apparatus 100 may be read as “process” or “step”.

### REFERENCE SIGNS LIST

100: anonymization-processing evaluation apparatus, 100S: anonymization-processing evaluation system, 101: processor, 102: memory, 103: auxiliary storage device, 104: communication device, 105: input/output interface, 109: processing circuitry, 110: data reception unit, 120: means evaluation unit, 130: criterion evaluation unit, 140: result output unit, 150: program analysis unit, 191: personal information data, 192: anonymization-processed data, 193: anonymization-processing means data, 194: criterion determination data, 195: evaluation screen, 196: anonymization-processing program, 197: anonymization-processing code data, 198: anonymization-processing means data.

1. An anonymization-processing evaluation system comprising:
processing circuitry
to receive personal information data indicating personal information, anonymization-processed data indicating anonymization-processed personal information, and means-specifying data for specifying an anonymization-processing rule which is for the personal information;
to perform, based on the personal information data and the anonymization-processed data, means evaluation which determines whether or not conversion from the personal information into the anonymization-processed personal information has been performed by applying the anonymization-processing rule specified by the means-specifying data;
to perform, based on criterion determination data indicating one or more criterion determination rules for one or more anonymization-processing criteria, criterion evaluation which determines an anonymization-processing criterion for a criterion determination rule which is the same as the anonymization-processing rule specified by the means-specifying data; and
to integrate and output a result of the means evaluation and a result of the criterion evaluation.

2. The anonymization-processing evaluation system according to claim 1,
wherein the means-specifying data is anonymization-processing means data indicating the anonymization-processing rule, and
wherein the processing circuitry
performs the means evaluation on the anonymization-processing rule indicated in the anonymization-processing means data, and
performs the criterion evaluation on the anonymization-processing rule indicated in the anonymization-processing means data.

3. The anonymization-processing evaluation system according to claim 1,
wherein the means-specifying data is an anonymization-processing program for performing anonymization processing according to the anonymization-processing rule, and
wherein the processing circuitry
specifies the anonymization-processing rule by analyzing the anonymization-processing program,
performs the means evaluation on the specified anonymization-processing rule, and
performs the criterion evaluation on the specified anonymization-processing rule.

4. An anonymization-processing evaluation method comprising:
receiving personal information data indicating personal information, anonymization-processed data indicating anonymization-processed personal information, and means-specifying data for specifying an anonymization-processing rule which is for the personal information;
performing means evaluation which determines whether or not conversion from the personal information into the anonymization-processed personal information has been performed by applying the anonymization-processing rule specified by the means-specifying data, based on the personal information data and the anonymization-processed data;
performing criterion evaluation which determines an anonymization-processing criterion for a criterion determination rule which is the same as the anonymization-processing rule specified by the means-specifying data, based on criterion determination data indicating one or more criterion determination rules for one or more anonymization-processing criteria; and
integrating and outputting a result of the means evaluation and a result of the criterion evaluation.

5. A non-transitory computer readable medium storing an anonymization-processing evaluation program which causes a computer to execute:
a data reception process of receiving personal information data indicating personal information, anonymization-processed data indicating anonymization-processed personal information, and means-specifying data for specifying an anonymization-processing rule which is for the personal information;
a means evaluation process of performing, based on the personal information data and the anonymization-processed data, means evaluation which determines whether or not conversion from the personal information into the anonymization-processed personal information has been performed by applying the anonymization-processing rule specified by the means-specifying data;
a criterion evaluation process of performing, based on criterion determination data indicating one or more criterion determination rules for one or more anonymization-processing criteria, criterion evaluation which determines an anonymization-processing criterion for a criterion determination rule which is the same as the anonymization-processing rule specified by the means-specifying data; and
a result output process of integrating and outputting a result of the means evaluation and a result of the criterion evaluation.
